(19) United States
(12) Patent Application Publication
(10) Pub. No.: US 2023/0257624 A1
(43) Pub. Date: Aug. 17, 2023

(54) AMORPHOUS COPOLYESTER RESIN FOR INDUSTRIAL COATINGS AND METHODS FOR COATING A METAL SURFACE USING SUCH COATING COMPOSITIONS

(71) Applicant: Bostik, Inc., Wauwatosa, WI (US)

(72) Inventors: Joshua HARJU, Milwaukee, WI (US); Deepa PUTHANPARAMBIL, Wauwatosa, WI (US)

(21) Appl. No.: 18/015,013

(22) PCT Filed: Jul. 7, 2021
(86) PCT No.: PCT/US21/40610

§ 371 Date: Jan. 6, 2023

Related U.S. Application Data
(60) Provisional application No. 63/049,198, filed on Jul. 8, 2020.

(51) Int. Cl. C09D 167/02; C08G 63/189; C08G 63/199

(52) U.S. Cl. CPC C09D 167/02; C08G 63/189; C08G 63/199

(57) ABSTRACT

A copolyester resin comprises the reaction product of at least two aliphatic diols and at least two aromatic diacids or diesters comprising a naphthalene-based monomer and terephthalic-based monomer and has a glass transition temperature between about 65° C. and about 95° C. A coating comprises a copolyester resin comprising the reaction product of at least two aliphatic diols and at least one aromatic diacid or diester comprising the naphthalene-based monomer; a cross-linker; and metal catalyst. The coating composition may be solvated and provides excellent retort resistance, flexibility, chemical resistance, and ability to bond to metal substrates, including tin-plated steel. The copolyester resin may be food grade compliant and alcohol compliant, making it suitable for use as a can coating, especially for beverages and even alcoholic beverages with no restrictions on the alcohol content.

### FIELD OF THE INVENTION

This invention relates to copolyester resin compositions and coating compositions comprising the copolyester resin capable of being solvated and useful as an industrial coating, particularly as a coating for a metal surface. The invention also relates to the methods for applying such coating compositions to metal surfaces, especially for beverages including alcoholic beverages, and the articles bearing such coatings.

### BACKGROUND OF THE INVENTION

A wide variety of coatings have been used to coat the surfaces of food and beverage cans, including two-piece and three-piece metal food and beverage cans. These cans are generally coated using “coil coating” operations, in which a planar sheet of a suitable substrate (e.g., steel or aluminum) is coated with a suitable composition, cured, and then the coated substrate is formed into the can end or the can body. The coating should be capable of high speed application to the substrate and provide the necessary properties when cured to perform in this demanding end use. For example, the coating should be safe for food contact, have excellent adhesion to the substrate, and be capable of being drawn during the forming step and providing clean edges (when used as an end coating) when the end is opened. In addition, the coating used for the inner surface of such a can is required to not impair the flavor of the contents, must be non-toxic, must be able to be solvated yet be chemically and mechanically resistant after curing, and still must be flexible. In addition, for use with cans storing alcoholic beverages, the coating must comprise only alcohol compliant materials.

Previous coatings have suffered from one or more deficiencies. For example, many current coatings contained mobile or bound bisphenol A (“BPA”) or aromatic glycidyl ether compounds or PVC compounds. These compounds are perceived as being potentially harmful to human health. Consequently, there is a strong desire to eliminate these compounds from coatings used to coat food or beverage cans.

Copolyester resins have been explored as a possible coating for metal cans for food or beverages. Many current high performance, high molecular weight can coatings stress the need for a glass transition (Tg) temperature of greater than 100° C. to bolster barrier properties and chemical resistance, though this typically creates a problem with the flexibility that is required of the product. U.S. Patent Application Publication No. 20140350211, for example, describes a copolyester resin comprising the reaction product of dimethyl terephthalate, 1,4-butanediol, and tricyclo[2.2.1]decanedimethanol (TCD-DM), and having a glass transition temperature 104° C.

Japanese Patent Application No. 2001/019876 provides a coating composition for cans, particularly for the inner surface of a can, which provides excellent adhesion to a metal plate, good workability, good curability, suppressed dissolution, and good retort sterilization resistance. The coating composition comprises (A) a thermoplastic copolyester resin having an acid value of 15 or less, a hydroxyl number of 20 or less, and a number average molecular weight of 11,000 daltons or more, and (B) a thermosetting resin in a ratio of A:B of about 90:10.

International Application No. WO 2013/046688 describes is a resin-coated metal sheet which is for a container and which can adapt to the various properties required of a material for food cans. A resin coating layer (A) having a multi-layer structure and having a copolyester resin as the main component thereof is included on at least one surface of a metal sheet. The resin coating layer (A) is adhered to the surface of the metal sheet and comprises a resin layer (a1) including (i) polyester resin and (ii) at least one component selected from the group consisting of polyamine resin, polyamideamine resin, and polyamide resin, with the copolyester resin being the main component. It is preferable that a polyester film (a2) is formed on the upper layer of the resin layer (a1).

U.S. Pat. No. 9,187,213 discloses food and beverage cans having a coating composition applied to at least a portion of a surface thereon. The coating composition includes at least a film-forming amount of a copolyester resin having a backbone that includes one or more soft segments and a plurality of hard segments. The copolyester resin preferably has a glass transition temperature from about from about 10° C. to about 50° C. The soft segments are obtained by using either aliphatic, linear diacids or dimer fatty diols as monomers to form those regions.

### SUMMARY OF THE INVENTION

In order to meet at least some of the needs described herein and not met by various prior art references, the present invention provides a high molecular weight, amorphous copolyester resin and a solvent-based industrial coating that contains the copolyester resin, a crosslinker, and a catalyst. According to embodiments of the invention, the coating composition which is the solvated coating is clear, stable, and has a suitable viscosity at the application temperature for processing. Metallic substrates coated with cured coatings of embodiments of the present invention have a continuous barrier with high flexibility and strong chemical resistance to destructive testing such as steam sterilization retort testing with acidic media. Copolyester resin compositions of embodiments of the invention are substantially or entirely globally compliant for direct food contact application and have no restriction on alcohol usage compliance. This allows the copolyester resin to also be used in the food and beverage can coatings industries, particularly for containers for alcoholic (i.e., alcohol-containing) beverages.

According to an embodiment of the invention, a composition comprises an amorphous copolyester resin comprising the reaction product of at least two aliphatic diols and at least two aromatic diacids or diesters, wherein the at least two aromatic diacids or diesters comprise a naphthalene-based monomer in an amount of at least 20 mol %, preferably at least 22.5 mol %, and more preferably at least 25 mol % and at most 60 mol % based on the total moles of diacids and diesters and a terephthalic-based monomer in an amount of at least 20 mol %, preferably 35 mol %, and at most 60 mol %, preferably at most 45 mol %, based on the total moles of diacids and diesters and having a glass transition temperature between about 65° C. and about 95° C., preferably between about 73° C. and about 81° C.

According to another embodiment of the invention, a coating composition comprises: an amorphous copolyester resin having a glass transition temperature between about 65° C. and 95° C., preferably between about 73° C. and about 81° C., and comprising the reaction product of at least two aliphatic diols and at least one aromatic diacid or diester, wherein said at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid and diester; a cross-linker; and a metal catalyst.

According to another embodiment of the invention, a method of coating a metal surface comprises the steps of: (a) combining a coating composition with a solvent to form a mixture (also referred to herein as a solvated coating composition), wherein the coating composition comprises: (i) an amorphous copolyester resin having a glass transition temperature between about 65° C. and 95° C., preferably between about 73° C. and about 81° C., and comprising the reaction product of at least two aliphatic diols and at least one aromatic diacid or diester, wherein the at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid; (ii) a cross-linker; and (iii) a metal catalyst; (b) applying the solvated coating composition to the metal surface; and (c) curing the solvated coating composition to form a coated metal substrate.

According to another embodiment of the invention, a coated article comprises a metal substrate and a coating, disposed on the metal substrate, and comprising a cross-linked copolyester resin, wherein said resin comprises residues of at least one aliphatic diol and at least one aromatic diacid or diester comprising a naphthalene-based monomer, wherein said coating provides a blush resistance test rating of at least 4, preferably at least 4.5; a wedge bend percentage of at least 70%, preferably at least 75%; a solvent resistance rating using methyl ethyl ketone of at least 30 double rubs, preferably at least 40 double rubs; an adhesion test rating of at least 8, preferably at least 9; and a pencil test rating of 8H or harder.

### DETAILED DESCRIPTION OF THE INVENTION

The present invention may be understood more readily by reference to the following detailed description of certain embodiments of the invention and the working examples.

The term “copolyester” is understood to mean a synthetic polymer prepared by the reaction of one or more difunctional carboxylic acids or esters (i.e., diacids or diesters) with one or more difunctional hydroxyl compounds (i.e., diols).

The term “residue,” as used herein, means any organic structure incorporated into a polymer through a condensation reaction, an esterification reaction, or a transesterification reaction from the corresponding monomers. For example, a residue of a diacid or diester monomer is the remaining structure of that monomer as it exists in the copolyester, namely without the hydrogen atoms or the alkyl groups that have been consumed as part of the reaction of the diacid or diester, respectively, with a hydroxyl group. A residue of a diol monomer is the remaining structure of that monomer as it exists in the copolyester, namely without the oxygen and hydrogen atoms that have been consumed as part of the reaction with an diacid or diester in an esterification or transesterification reaction, respectively.

An embodiment of the invention provides a composition comprising an amorphous copolyester resin. As used herein, “amorphous” means a material that is essentially amorphous, such as having a heat of fusion of less than 5 Joules/gram, preferably less than 1 Joules/gram, and most preferably essentially zero Joules/gram. Heat of fusion values provided herein are determined according to ASTM E793-01 “Standard Test Method for Enthalpies of Fusion and Crystallization by Differential Scanning Calorimetry.”

According to an embodiment of the invention directed to the copolyester resin itself, the copolyester resin comprises the reaction product of at least two aliphatic diols and at least two aromatic diacids or diesters. The aliphatic diols may have up to 20, preferably up to 16, and most preferably up to 12 carbon atoms. Similarly, the aromatic diacids and diesters may have up to 20, preferably up to 16, and most preferably up to 12 carbon atoms. The at least two aromatic diacids or diesters comprise a naphthalene-based monomer in an amount of at least 20 mol %, preferably at least 22.5 mol %, and more preferably at least 25 mol % and at most 60 mol % and a terephthalic-based monomer in an amount of at least 20 mol %, preferably 35 mol %, and at most 60 mol %, preferably at most 45 mol %, based on the total moles of diacids and diesters. When a lower limit and an upper limit of a constituent is identified herein, the invention includes the use of that constituent in an amount extending from any such lower limit to any such upper limit. The copolyester resin has a glass transition temperature between about 65° C. and about 95° C., preferably between about 73° C. and about 81° C. The glass transition temperature as described herein is measured using Differential Scanning Calorimetry (DSC) according to ASTM E-794-01 except with one modification to the test in that a scanning temperature of 15° C. per minute instead of 10° C. per minute was used. The term “reaction product” as used herein refers to any product of an esterification or transesterification reaction of any of the monomers used in making the copolyester, including an oligomer or the final copolyester, reacted to a certain acid number and hydroxyl number.

In an embodiment of the invention, all of the diol components are aliphatic. In a preferred embodiment, the at least two aliphatic diols comprise ethylene glycol, diethylene glycol, cyclohexanedimethanol, neopentyl glycol, 1,4-butane diol, and methyl-1,3-propanediol, preferably comprise, consist essentially of, or consist of ethylene glycol, diethylene glycol, cyclohexanedimethanol. The ethylene glycol may be present in an amount of 55-80 mol %, preferably 65-75 mol %, based on the total moles of diols; the diethylene glycol is present in an amount of 5-40 mol %, preferably 7-15 mol %, based on the total moles of diols; and the cyclohexanedimethanol is present in an amount of 10-35 mol %, preferably 15-25 mol %, based on the total moles of diols.

In an embodiment of the invention, all of the diacid and diester components are aromatic. As is known in making copolyester, either an acid or an ester may be used in combination with an alcohol to form the copolyester resin by an esterification reaction or a transesterification, respectively. The naphthalene-based monomer is either a diacid or a diester. It may be selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, dimethyl 2,6-naphthalene dicarboxylic acid, dimethyl 2,6-naphthalene dicarboxylate, and dimethyl 2,7-naphthalene dicarboxylate. Preferably, the naphthalene-based monomer is 2,6-naphthalene dicarboxylic acid or dimethyl 2,6-naphthalene dicarboxylate, and most preferably is dimethyl 2,6-naphthalene dicarboxylate. Similarly, the terephthalic-based monomer is either dimethyl terephthalate or terephthalic acid, and preferably is dimethyl terephthalate.

According to an embodiment of the invention, the at least two aromatic diacids or diesters further comprise an isophthalic-based monomer, which is a diacid or a diester, such as either isophthalic acid or dimethyl isophthalate, in addition to the naphthalene-based monomer and terephthalic-based monomer.

In preferred embodiments, isophthalic acid is present in an amount of 15-50 mol %, preferably 25-35 mol %, based on the total moles of diacid and diester. Preferably, dimethyl 2,6-naphthalene dicarboxylate is present in an amount of 25-35 mol %, based on the total moles of diacids and diesters. Preferably, dimethyl terephthalate is present in an amount of at least 20 mol %, preferably 35 mol %, and at most 60 mol %, preferably at most 45 mol %, based on the total moles of diacids and diesters.

Certain preferred embodiments of the invention relate to the monomers used, and some not used, in making the copolyester resin. According to one such embodiment of the invention, the only source of ether groups in the copolyester resin is diethylene glycol and the amount of diethylene glycol based on the total moles of the diols is at most 30 mol %, preferably at most 20 mol %, and most preferably at most 15 mol %. As used herein, a source of ether groups is a monomer which, when reacted in the form of its residue as part of the coplyester resin, forms an ether group. It has been found that limiting the amount of sources of ether groups improves the ability of the copolyester resin to resist hyrdrolysis. According to another embodiment of the invention, ethylene glycol is present as one of the at least two aliphatic diols, and the combined amount of the ethylene glycol molar fraction based on the total moles of the diols and dimethyl terephthalate (or terephthalic acid) molar fraction based on the total moles of the diacids and diesters is less than 1.3, preferably less than 1.25, most preferably less than 1.2. It should be recognized that this sum is of molar fractions of different bases, one of the total moles of diols and the other of the total moles of the diacids and diesters. Total molar fraction of these two monomers above 1.3 tends to make the copolyester resin more difficult to solvate. According to another embodiment of the invention, diethylene glycol is present as one of the at least two aliphatic diols and isophthalic acid is present as one of the at least two aromatic diacids or diesters, and the combined amount of diethylene glycol molar fraction based on the total moles of the diols and isophthalic acid molar fraction based on the total moles of the diacids and diesters is at least 0.25, preferably at least 0.3, and most preferably at least 0.35. As before, this sum is of molar fractions of different bases, one of the total moles of diols and the other of the total moles of the diacids and diesters. According to another embodiment of the invention, all of the diol components consist of primary alcohols. According to another embodiment of the invention, the copolyester resin does not comprise any residue of neopentyl glycol or 2-methyl-1,3-propanediol. Stated another way, neither neopentyl glycol or 2-methyl-1,3-propanediol is used in making the copolyester resin according to this embodiment. In another embodiment, no butane diol is used in making the copolyester resin. Also, in a preferred embodiment, no polyethylene glycol is used in making the copolyester resin. In still another embodiment, no aliphatic, linear diacids or diesters and no dimer fatty diols are used in making the copolyester resin.

Certain preferred embodiments of the copolyester resin of the present invention relate to the properties of the copolyester resin as formed. In one such embodiment, the amorphous copolyester resin has an acid number of less than 5 mg KOH/g, preferably less than 3 mg KOH/g but greater than 0.1 mg KOH/g, preferably greater than 0.5 mg KOH/g. The acid number as used herein is determined in accordance with DIN EN ISO 2114. The specimen to be investigated is dissolved in dichloromethane and methanol (80:20 volumetric blend) and titrated with 0.1 N sodium hydroxide solution in the presence of phenolphthalein. The acid number is the amount of milligrams of potassium hydroxide required to neutralize the acid present in one gram polymer. The acid number is a measure of the extent of reaction in forming the copolyester resin and decreases as the reaction progresses.

According to another preferred embodiment of the copolyester resin of the present invention, the hydroxyl number is less than 20 mg KOH/g, preferably less 17 mg KOH/g but greater than 5 mg KOH/g, preferably greater than 8 mg KOH/g. The hydroxyl number as used herein is determined in accordance with DIN 53240-2. The hydroxyl number of a hydroxyl-containing polymer of the present invention is determined by: (i) esterifying the polymer with acetic anhydride and pyridine to obtain an esterified polymer and acetic acid; and (ii) then neutralizing the acetic acid with potassium hydroxide. The units are expressed similarly to acid number, i.e., the number of milligrams of potassium hydroxide required to neutralize the acetic acid formed as described above per one gram of polymer. The hydroxyl number is also a measure of the extent of reaction in forming the copolyester resin and decreases as the reaction progresses.

In another embodiment of the invention, the amorphous copolyester resin has a number average molecular weight (Mn) of between about 8000 to 30,000 daltons, preferably between about 17,000 and 24,000 daltons, and a weight average molecular weight (Mw) of between about 20,000 to 45,000 daltons, preferably between about 27,000 to 40,000 daltons. Number average molecular weight and weight average molecular weight are determined in accordance with DIN 55672-1 using a size exclusion chromatography (SEC) using polystyrene reference standards and THF as the solvent. In yet another embodiment of the invention, the amorphous copolyester resin has a Brookfield Thermosel melt viscosity at 215° C. of between 85,000 and 500,000 cP with a #29 spindle at 0.5 rpm. In yet another embodiment of the invention, the intrinsic viscosity of the copolyester resin is between about 0.3 dl/g to about 0.6 dl/g, preferably between about 0.35 dl/g to about 0.55 dl/g. As used herein, intrinsic viscosity is determined in accordance with ASTM D5225-14. Both the molecular weight and the viscosity of the copolyester resin increase as the reaction progresses.

The copolyester used in the present invention may be produced by any conventional method for producing a copolyester by a transesterification method or a direct esterification method. However, in consideration of food applications, use of heavy metals or compounds that pose a problem in hygiene as catalysts and additives should be avoided or limited. The copolyesters used in the present invention typically can be prepared from diacids or diesters and diols which react in substantially equal proportions and are incorporated into the copolyester polymer as their corresponding residues. As is well-known, the diols are added in excess, because unreacted diols are more easily evaporated than unreacted diacids or diesters. The copolyesters of the present invention, therefore, can contain substantially equal molar proportions of diacid or diester residues and diol residues. The mole percentages provided in the present disclosure, therefore, may be based on the total moles of diacid and diester residues or the total moles of diol residues.

Suitable methods include, but are not limited to, the steps of reacting one or more dicarboxylic acids with two or more diols at a temperature of 100° C. to 315° C. at a pressure of 0.1 to 760 mm Hg for a time sufficient to form a polyester. U.S. Pat. No. 3,772,405, incorporated herein by reference, describes suitable methods of producing copolyesters. In one process for making the copolyester resin, the process comprises: (I) heating a mixture comprising the selected monomers useful in any of the copolyesters of the invention in the presence of a catalyst at a temperature of 150 to 240° C. for a time sufficient to produce an initial polyester; (II) heating the initial polyester of step (I) at a temperature of 240 to 320° C. for 1 to 4 hours; and (III) removing any unreacted glycols.

Suitable catalysts for use in this process include, but are not limited to, organo-zinc, titanium, or tin compounds, although organo-tin compounds are not preferred for food and beverage applications. The use of this type of catalyst is well-known in the art. Examples of catalysts useful in the present invention include, but are not limited to, zinc acetate dihydrate, butyltin tris-2-ethylhexanoate, dibutyltin diacetate, titanium (IV) 2-ethylhexyloxide, titanium (IV) butoxide and/or dibutyltin oxide. Other catalysts may include, but are not limited to, those based on manganese, lithium, germanium, and cobalt. Catalyst amounts can range from 10 ppm to 20,000 ppm or 10 to 10,000 ppm, or to 5000 ppm or 10 to 1000 ppm or 10 to 500 ppm, or 10 to 300 ppm or 10 to 250 based on the catalyst metal and the weight of the final polymer. The process can be carried out in either a batch or continuous process.

Another embodiment of the invention provides a coating composition comprising an amorphous copolyester resin; a cross-linker; and a metal catalyst. In this embodiment, the copolyester resin has a glass transition temperature between about 65° C. and 95° C., preferably between about 73° C. and about 81° C., and comprises the reaction product of at least two aliphatic diols and at least one aromatic diacid or diester. The at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid and diester.

In an aspect of the coating composition embodiment of the invention, all of the diol components are aliphatic. In a preferred aspect, the at least two aliphatic diols comprise ethylene glycol, diethylene glycol, cyclohexanedimethanol, neopentyl glycol, 1,4-butane diol, and methyl-1,3-propanediol, preferably comprise, consist essentially of, or consist of ethylene glycol, diethylene glycol, cyclohexanedimethanol. The ethylene glycol may be present in an amount of 55-80 mol %, preferably 65-75 mol %, based on the total moles of diols; the diethylene glycol is present in an amount of 5-40 mol %, preferably 7-15 mol %, based on the total moles of diols; and the cyclohexanedimethanol is present in an amount of 10-35 mol %, preferably 15-25 mol %, based on the total moles of diols.

In another aspect of the coating composition embodiment of the invention, all of the diacid and diester components are aromatic. The naphthalene-based monomer may be selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, 2,6-naphthalene dicarboxylic acid, dimethyl 2,6-naphthalene dicarboxylate, and dimethyl 2,7-naphthalene dicarboxylate. Preferably, the naphthalene-based monomer is 2,6-naphthalene dicarboxylic acid or dimethyl 2,6-naphthalene dicarboxylate, most preferably is dimethyl 2,6-naphthalene dicarboxylate.

According to another aspect of this coating composition embodiment of the invention, the at least two aromatic diacids or diesters further comprise a terephthalic-based monomer and an isophthalic-based monomer, in addition to the naphthalene-based monomer. The terephthalic based monomer may be terephthalic acid or dimethyl terephthalate and may be present in an amount of 20-60 mol %, preferably 35-45 mol %, based on the total moles of diacid. The isophthalic-based monomer may be isophthalic acid or dimethyl isophthalate and may be present in an amount of 15-50 mol %, preferably 25-35 mol %, based on the total moles of diacid and diester. The dimethyl 2,6-naphthalene dicarboxylate may be present in an amount of 25-35 mol %, based on the total moles of diacids and diesters.

Certain preferred aspects of this embodiment of the invention relate to the monomers used, and some not used, in making the copolyester resin. According to one such aspect, the only source of ether groups in the copolyester resin is diethylene glycol and the amount of diethylene glycol based on the total moles of the diols is at most 30 mol %, preferably at most 20 mol %, and most preferably at most 15 mol %. According to another such aspect, ethylene glycol is present as one of the at least two aliphatic diols and dimethyl terephthalate (or terephthalic acid) is present as one of the at least one diacid or diester, and the combined amount of ethylene glycol molar fraction based on the total moles of the diols and dimethyl terephthalate (or terephthalic acid) molar fraction based on the total moles of the diacids and diesters is less than 1.3, preferably less than 1.25, most preferably less than 1.2. According to another aspect, diethylene glycol is present as one of the at least two aliphatic diols and isophthalic acid is present as one of the at least two aromatic diacids or diesters, and the combined amount of diethylene glycol molar fraction based on the total moles of the diols and isophthalic acid molar fraction based on the total moles of the diacids and diesters is at least 0.25, preferably at least 0.3, and most preferably at least 0.35. According to another embodiment of the invention, all of the diol components consist of primary alcohols. According to another embodiment of the invention, the copolyester does not comprise any residue of neopentyl glycol or 2-methyl-1,3-propanediol. Stated another way, neither neopentyl glycol or 2-methyl-1,3-propanediol is used in making the copolyester resin. In another embodiment, no butane diol is used in making the copolyester resin. Also, in a preferred embodiment, no polyethylene glycol is used in making the copolyester resin. In still another embodiment, no aliphatic, linear diacids or dimer fatty diols are used in making the copolyester resin.

Certain preferred aspects of this coating composition embodiment relate to the properties of the copolyester resin as formed. In one such aspect, the amorphous copolyester resin has an acid number of less than 5 mg KOH/g, preferably less than 3 mg KOH/g but greater than 0.1 mg KOH/g, preferably greater than 0.5 mg KOH/g. In another such aspect, the hydroxyl number is less than 20 mg KOH/g, preferably less 17 mg KOH/g but greater than 5 mg KOH/g, preferably greater than 8 mg KOH/g. In another such aspect, the amorphous copolyester resin has a number average molecular weight (Mn) of between about 8000 to 30,000 daltons, preferably between about 17,000 and 24,000 daltons, and a weight average molecular weight (Mw) of between about 20,000 to 45,000 daltons, preferably between about 27,000 to 40,000 daltons. In another such aspect, the amorphous copolyester resin has a Brookfield Thermosel melt viscosity at 215° C. of between 85,000 and 500,000 cP with a #29 spindle at 0.5 rpm. In yet another aspect, the intrinsic viscosity of the copolyester resin is between about 0.3 dl/g to about 0.6 dl/g, preferably between about 0.35 dl/g to about 0.55 dl/g.

In an embodiment of the invention, the copolyester resin (prior to solvation) is in the form of pellets. Alternative forms include granules, chopped rods, or powder.

In accordance with this embodiment of the invention, the coating composition further comprises a cross-linker. Any suitable cross-linker can be used in accordance with this embodiment of the invention. The cross-linker may be selected from the group consisting of an amine, a blocked isocyanate, and a phenolic resin, and mixtures thereof. Typical blend include 20% amine/10% blocked isocyanate or 15% amine/10% phenolic/5% blocked isocyanate, based on the weight of the copolyester resin. The cross-linker preferably has an activation temperature above 75° C., more preferably 100° C., still more preferably 125° C., and most preferably above 145° C. These preferred embodiments show improved shelf stability. Examples of suitable cross-linkers include, without limitation, benzoguanamine-formaldehyde resins, melamine-formaldehyde resins, and urea-formaldehyde resins. Particularly useful crosslinker is the fully alkylated benzoguanamine-formaldehyde resin commercially available from Cytec Industries, Inc. under the trademark of CYMEL 1123.

As mentioned above, the coating composition further comprises a metal catalyst. Preferably, the catalyst serves to increase the rate of cure. The catalyst is preferably present in an amount of about 0.01% (by weight) to about 1%, more preferably about 0.05% to about 1%, and most preferably about 0.1 to about 0.5% of nonvolatile material. Examples of catalysts, include, but are not limited to, strong acids (e.g., dodecylbenzene sulphonic acid), quaternary ammonium compounds, phosphorous compounds, and tin and zinc compounds, like a tetraalkyl ammonium halide, a tetraalkyl or tetraaryl phosphonium iodide or acetate, tin octoate, zinc octoate, triphenylphosphine, and similar catalysts known to persons skilled in the art. Particularly preferred are para-toluene sulfonic acid or phosphoric acid catalysts commercially available from Cytec Industries, Inc. under the trademark CYCAT 4040.

The coating composition of the present invention may also include other optional ingredients that do not adversely affect the coating composition or a cured coating composition resulting therefrom. Such optional ingredients are typically included in a coating composition to enhance composition aesthetics, to facilitate manufacturing, processing, handling, and application of the composition, and to further improve a particular functional property of a coating composition or a cured coating composition resulting therefrom.

Such optional ingredients include, for example, dyes, pigments, toners, extenders, fillers, lubricants, anticorrosion agents, flow control agents, thixotropic agents, dispersing agents, antioxidants, adhesion promoters, light stabilizers, and mixtures thereof. Each optional ingredient is included in a sufficient amount to serve its intended purpose, but not in such an amount to adversely affect a coating composition or a cured coating composition resulting therefrom.

Another useful optional ingredient is a lubricant, like a wax, which facilitates manufacture of metal closures by imparting lubricity to sheets of coated metal substrate. A lubricant is preferably present in the coating composition in an amount of about 0.01% to about 2%, and preferably about 0.1 to about 2%, by weight of nonvolatile material. Preferred lubricants include, for example, carnauba wax and polyethylene type lubricants.

The constituents of the coating composition of the invention may vary over a broad range depending on the desired viscosity and other properties. In an embodiment of the invention, the amorphous copolyester resin is present in an amount of about 60-85 wt %, preferably about 67-80 wt %, on a dry weight basis; the cross-linker is present in an amount of about 15-35 wt %, preferably about 20-32.5 wt %, on a dry weight basis; and the catalyst is present in an amount of about 0.1-3 wt %, preferably about 0.5-1.5 wt %, on a dry weight basis. In this context, dry weigh basis refers to the sum of the amounts of the copolyester resin, the cross-linker, and the catalyst.

In accordance with the present invention, the coating composition further comprises a solvent. As used herein, a solvent may contemplate a single solvent or a mixture of solvents. The solvent used will depend on the solubility characteristics of the coating composition prior to solvation and the end use. A wide range of solvents may be used, depending on these factors. According to an embodiment of the invention, the solvent is selected from the group consisting of dibasic esters, cyclohexanone, aromatic 100, aromatic 150, aromatic 200, methyl propyl acetate, and methyl propyl ketone and mixtures thereof. Suitable solvent (or solvent mixtures) include dibasic esters (DBE); cyclohexanone; a 70:30 aromatic 100:cyclohexanone blend; a 90:10 dibasic esters:methyl propyl acetate blend; an 85:10:5 DBE:cyclohexanone:aromatic 100 blend; an 80:20 DBE:methyl propyl ketone blend; a 60:40 methyl propyl ketone:cyclohexanone blend; and a 60:40 toluene:methyl ethyl ketone. In making the solvated coating composition according to an embodiment of the invention, the coating composition of the amorphous copolyester resin, the cross-linker, and the catalyst is combined with a solvent in a known way to form a solvated coating composition. This can be done by mixing at room temperature.

The amount of solvent included in the composition is limited only by the desired, or necessary, rheological properties of the solvated coating composition. Usually, a sufficient amount of solvent is included in the coating composition to provide a composition that can be processed easily and that can be applied to a metal substrate easily and uniformly, and that is sufficiently removed from the coating composition during curing within the desired cure time. The solids content of the coating compositions may vary over a wide range, depending on the application method and the desired properties, including between 10 to 70% solids and 20 to 35% solids. Similarly, the viscosity of the solvated coating composition may vary over a wide range. In one application, the solution viscosity is between 50-100 seconds, preferably 50-70 seconds, using an ISO6 viscosity cup at 25° C.

In accordance with another embodiment of the invention, a method of coating a metal surface comprises the steps of combining a coating composition with a solvent to form a solvated coating composition; applying the solvated coating composition to the metal surface; and curing the coating composition to form a coated metal substrate. In the curing step, the solvent is evaporated as the resin undergoes cross-linking. In this embodiment, the amorphous copolyester resin has a glass transition temperature between about 65° C. and 95° C., preferably between about 73° C. and about 81° C., and comprises the reaction product of at least two aliphatic diols and at least one aromatic diacid or diester, wherein the at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid. The combining step may be done in any conventional way, such as by simply mixing the constituents together to form the solvated coating composition. The solvated coating composition may be applied to the metal surface in any suitable way, such as by immersion or dip coating, roll-coating, spraying, knife over-roll coating. The curing step involves heating for a time and at a temperature sufficient to cause the solvent to evaporate and the copolyester resin to undergo suitable cross-linking to bond to the metal surface. One suitable set of conditions is exposure to 12 minutes at 204° C.

According to this embodiment, the metal may comprise tin-plated steel and tin-free steel. In a preferred embodiment of the invention, the metal is in the shape of a container and is adapted to contain a food or beverage. In still a further embodiment of the invention, the beverage is an alcoholic beverage.

The invention further relates to articles of manufacture. The articles include metal containers, metal packaging, metal cans, metal can lids, food and beverage containers, food and beverage cans. The aforementioned coating compositions are particularly well adapted for use as a coating for two-piece cans. Two-piece cans are manufactured by joining a can body (typically a drawn metal body) with a can end (typically a drawn metal end). The coatings of the present invention are suitable for use in food contact situations and may be used on the inside of such cans. The coatings are also suited for use on the exterior of the cans. Notably, the present coatings are well adapted for use in a coil coating operation. In this operation, a coil of a suitable substrate (e.g., aluminum or steel sheet metal) is first coated with the coating composition of the present invention (on one or both sides), cured (e.g., using a bake process), and then the cured substrate is formed (e.g., by stamping or drawing) into the can end or can body or both. The can end and can body are then sealed together with a food or beverage contained therein.

According to another embodiment of the invention, a coated article comprises a metal substrate and a coating, disposed on the metal substrate, having a glass transition temperature between about 65° C. and 95° C., preferably between about 73° C. and about 81° C. and comprising a cross-linked copolyester resin made by curing any coating composition according to the present invention. In another embodiment, the resin comprises residues of at least one aliphatic diol and at least one aromatic diacid or diester comprising a naphthalene-based monomer, preferably in an amount of at least 20 mol %, preferably at least 22.5 mol %, and more preferably at least 25 mol % and at most 60 mol % based on the total moles of diacids and diesters, wherein the coating provides a blush resistance test rating of at least 4, preferably at least 4.5; a wedge bend percentage of at least 70%, preferably at least 75%; a solvent resistance rating using methyl ethyl ketone of at least 30 double rubs, preferably at least 40 double rubs; an adhesion test rating of at least 8, preferably at least 9; and a pencil test rating of 8H or harder. As used herein, the blush resistance test refers to all of the following conditions: deionized liquid water and deionized water vapor; 1% sodium chloride in both liquid water and water vapor; or 3% acetic acid in both liquid water and water vapor.

In preferred embodiments (e.g., for use with alcoholic beverage cans), the diol monomers used to make the copolyester resin are substantially free of neopentyl glycol and 2-methyl-1,3-propanediol, more preferably completely free of neopentyl glycol and 2-methyl-1,3-propanediol. Preferred embodiments of the invention are substantially or completely free of bisphenol A (both free and bound forms) and aromatic glycidyl ether compounds [e.g., BADGE, BFDGE and epoxy novalacs].

In a preferred embodiment of the invention, an amorphous copolyester resin has a glass transition temperature between about 65° C. and about 95° C., preferably between about 73° C. and about 81° C. and comprises the reaction product of: a naphthalene-based monomer in an amount of at least 20 mol %, preferably at least 22.5 mol %, and more preferably at least 25 mol % and at most 60 mol % based on the total moles of diacids and diesters; a terephthalic-based monomer in an amount of at least 20 mol %, preferably 35 mol %, and at most 60 mol %, preferably at most 45 mol %, based on the total moles of diacids and diesters; an isophthalic-based monomer in an amount of 15-50 mol %, preferably 25-35 mol %, based on the total moles of diacid and diester; ethylene glycol in an amount of 55-80 mol %, preferably 65-75 mol %, based on the total moles of diols; diethylene glycol in an amount of 5-40 mol %, preferably 7-15 mol %, based on the total moles of diols; and cyclohexanedimethanol in an amount of 10-35 mol %, preferably 15-25 mol %, based on the total moles of diols. A preferred embodiment of the coating composition of the invention comprises such copolyester resin; a cross-linker; and a metal catalyst. A preferred embodiment of the method of coating a metal surface comprises the steps of (a) combining such a coating composition with a solvent to form a solvated coating composition; (b) applying the solvated coating composition to the metal surface; and (c) curing the solvated coating composition to form a coated metal substrate. A preferred embodiment of the coated article comprises a metal substrate and a coating, disposed on the metal substrate, and comprising a cross-linked copolyester resin made by curing such a coating composition.

### ASPECTS OF THE INVENTION

Aspect 1. A composition comprising an amorphous copolyester resin comprising the reaction product of at least two aliphatic diols and at least two aromatic diacids or diesters, wherein said at least two aromatic diacids or diesters comprise a naphthalene-based monomer in an amount of at least 20 mol %, preferably at least 22.5 mol %, and more preferably at least 25 mol % and at most 60 mol % and a terephthalic-based monomer in an amount of at least 20 mol %, preferably 35 mol %, and at most 60 mol %, preferably at most 45 mol %, based on the total moles of diacids and diesters and having a glass transition temperature between about 65° C. and about 95° C., preferably between about 73° C. and about 81° C.
Aspect 2. The composition of aspect 1, wherein the copolyester does not comprise any residue of neopentyl glycol or 2-methyl-1,3-propanediol.
Aspect 3. The composition of aspects 1 or 2, wherein all of the diacid and diester components are aromatic and all of the diol components are aliphatic.
Aspect 4. The composition of any of aspects 1-3, wherein the at least two aliphatic diols comprise ethylene glycol, diethylene glycol, and cyclohexanedimethanol.
Aspect 5. The composition of aspect 4, wherein:
the ethylene glycol is present in an amount of 55-80 mol %, preferably 65-75 mol %, based on the total moles of diols;
the diethylene glycol is present in an amount of 5-40 mol %, preferably 7-15 mol %, based on the total moles of diols; and
the cyclohexanedimethanol is present in an amount of 10-35 mol %, preferably 15-25 mol %, based on the total moles of diols.
   Aspect 6. The composition of any of aspects 1-5, wherein the naphthalene-based monomer is selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, 2,6-naphthalene dicarboxylic acid, dimethyl 2,6-naphthalene dicarboxylate, and dimethyl 2,7-naphthalene dicarboxylate.
   Aspect 7. The composition of any of aspects 1-5, wherein naphthalene-based monomer is 2,6-naphthalene dicarboxylic acid or dimethyl 2,6-naphthalene dicarboxylate.
   Aspect 8. The composition of any of aspects 1-7, wherein the at least two aromatic diacids or diesters further comprise isophthalic-based monomer.
   Aspect 9. The composition of aspect 8, wherein naphthalene-based monomer is dimethyl 2,6-naphthalene dicarboxylate, the terephthalic-based monomer is dimethyl terephthalate, and the isophthalic-based monomer is isophthalic acid, and wherein:
the isophthalic acid is present in an amount of 15-50 mol %, preferably 25-35 mol %, based on the total moles of diacids and diesters; and
the 2,6-naphthalene dicarboxylate is present in an amount of 25-35 mol %, based on the total moles of diacids and diesters.
   Aspect 10. The composition of any of aspects 1-9, wherein the only source of ether groups in the copolyester resin is diethylene glycol and the amount of diethylene glycol based on the total moles of the diols is at most 30 mol %, preferably at most 20 mol %, and most preferably at most 15 mol %.
   Aspect 11. The composition of any of aspects 1-10, wherein the amorphous copolyester resin has an acid number of less than 5, preferably less than 3 mg KOH/g but greater than 0.1, preferably greater than 0.5 mg KOH/g, and a hydroxyl number of less than 20 mg KOH/g, preferably less 17 mg KOH/g but greater than 5 mg KOH/g, preferably greater than 8 mg KOH/g.
   Aspect 12. The composition of any of aspects 1-11, wherein the amorphous copolyester resin has a number average molecular weight (Mn) of between about 8000 to 30,000 daltons, preferably between about 17,000 and 24,000 daltons, and a weight average molecular weight (Mw) of between about 20,000 to 45,000 daltons, preferably between about 27,000 to 40,000 daltons.
   Aspect 13. The composition of any of aspects 1-12, wherein the amorphous copolyester resin has a Brookfield Thermosel melt viscosity at 215° C. of between 85,000 and 500,000 cP with a #29 spindle at 0.5 rpm and/or an intrinsic viscosity determined in accordance with ASTM D5225-14 between about 0.3 dl/g to about 0.6 dl/g, preferably between about 0.35 dl/g to about 0.55 dl/g.
   Aspect 14. The composition of any of aspects 1-13, wherein terephthalic-based monomer is dimethyl terephthalate, the at least two aliphatic diols comprise ethylene glycol, and the combined amount of ethylene glycol molar fraction based on the total moles of the diols and dimethyl terephthalate molar fraction based on the total moles of the diacids and diesters is less than 1.3, preferably less than 1.25, most preferably less than 1.2.
   Aspect 15. The composition of any of aspects 1-14, wherein the at least two aliphatic diols comprise diethylene glycol, the at least two aromatic diacids or diesters further comprise isophthalic acid, and the combined amount of diethylene glycol molar fraction based on the total moles of the diols and isophthalic acid molar fraction based on the total moles of the diacids and diesters is at least 0.25, preferably at least 0.3, and most preferably at least 0.35.
   Aspect 16. The composition of any of aspects 1-15, wherein all of the diol components consist of primary alcohols.
   Aspect 17. A coating composition comprising:
an amorphous copolyester resin having a glass transition temperature between about 65° C. and 95° C., preferably between about 73° C. and about 81° C., and comprising the reaction product of at least two aliphatic diols and at least one aromatic diacid or diester, wherein said at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid or diester;
a cross-linker; and
a metal catalyst.
   Aspect 18. The coating composition of aspect 17, wherein all of the diacid and diester components are aromatic and all of the diol components are aliphatic.
   Aspect 19. The coating composition of aspect 17 or 18, wherein the at least two aliphatic diols comprise ethylene glycol, diethylene glycol, and cyclohexanedimethanol.
   Aspect 20. The coating composition of any of aspect 19, wherein:
the ethylene glycol is present in an amount of 55-80 mol %, preferably 65-75 mol %, based on the total moles of diols;
the diethylene glycol is present in an amount of 5-40 mol %, preferably 7-15 mol %, based on the total moles of diols; and
the cyclohexanedimethanol is present in an amount of 10-35 mol %, preferably 15-25 mol %, based on the total moles of diols.
   Aspect 21. The coating composition of any of aspects 17-20, wherein naphthalene-based monomer is selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, 2,6-naphthalene dicarboxylic acid, dimethyl 2,6-naphthalene dicarboxylate, and dimethyl 2,7-naphthalene dicarboxylate.
   Aspect 22. The coating composition of any of aspects 17-20, wherein naphthalene-based monomer is 2,6-naphthalene dicarboxylic acid or dimethyl 2,6-naphthalene dicarboxylate.
   Aspect 23. The coating composition of any of aspects 17-22, wherein the at least one aromatic diacid further comprises a terephthalic-based monomer and an isophthalic-based monomer.
   Aspect 24. The coating composition of aspect 23, wherein naphthalene-based monomer is dimethyl 2,6-naphthalene dicarboxylate, the terephthalic-based monomer is dimethyl terephthalate, and the isophthalic-based monomer is isophthalic acid, and wherein:
the dimethyl terephthalate is present in an amount of 20-60 mol %, preferably 35-45 mol %, based on the total moles of diacid;
the isophthalic acid is present in an amount of 15-50 mol %, preferably 25-35 mol %, based on the total moles of diacid; and
the dimethyl 2,6-naphthalene dicarboxylate is present in an amount of 25-35 mol %, based on the total moles of diacid.
   Aspect 25. The coating composition of any of aspects 17-24, wherein the only source of glycol of ether groups in the copolyester resin is diethylene glycol and the amount of diethylene glycol based on the total moles of the diols is at most 30 mol %, preferably at most 20 mol %, and most preferably at most 15 mol %.
   Aspect 26. The coating composition of any of aspects 17-25, wherein the amorphous copolyester resin has an acid number of less than 5 mg KOH/g, preferably less than 3 mg KOH/g but greater than 0.1 mg KOH/g, preferably greater than 0.5 mg KOH/g, and a hydroxyl number of less than 20 mg KOH/g, preferably less 17 mg KOH/g but greater than 5 mg KOH/g, preferably greater than 8 mg KOH/g.
   Aspect 27. The coating composition of any of aspects 17-26, wherein the amorphous copolyester resin has a number average molecular weight (Mₙ) of between about 8,000 to 30,000 daltons, preferably between about 17,000 and 24,000 daltons, and a weight average molecular weight (M_{w}) of between about 20,000 to 45,000 daltons, preferably between about 27,000 to 40,000 daltons.
   Aspect 28. The coating composition of any of aspects 17-27, wherein the amorphous copolyester resin has a Brookfield Thermosel melt viscosity at 215° C. of between 85,000 and 500,000 cP with a #29 spindle at 0.5 rpm and/or an intrinsic viscosity determined in accordance with ASTM D5225-14 between about 0.3 dl/g to about 0.6 dl/g, preferably between about 0.35 dl/g to about 0.55 dl/g.
   Aspect 29. The coating composition of any of aspects 17-28, wherein the at least two aliphatic diols comprise ethylene glycol, the at least one aromatic diacid or diester further comprises dimethyl terephthalate, and the combined amount of ethylene glycol molar fraction based on the total moles of the diols and dimethyl terephthalate molar fraction based on the total moles of the diacids and diesters is less than 1.3, preferably less than 1.25, most preferably less than 1.2.
   Aspect 30. The coating composition of any of aspects 17-29, wherein the at least two aliphatic diols comprise diethylene glycol, the at least one aromatic diacid or diester further comprises isophthalic acid, and the combined amount of diethylene glycol molar fraction based on the total moles of the diols and isophthalic acid molar fraction based on the total moles of the diacids and diesters is at least 0.25, preferably at least 0.3, and most preferably at least 0.35.
   Aspect 31. The coating composition of any of aspects 17-30, wherein all of the diol components consist of primary alcohols.
   Aspect 32. The coating composition of any of aspects 17-31, wherein:
the amorphous copolyester resin is present in an amount of about 60-85 wt %, preferably about 67-80 wt %, on a dry weight basis;
the cross-linker is present in an amount of about 15-35 wt %, preferably about 20-32.5 wt %, on a dry weight basis; and
the catalyst is present in an amount of about 0.1-3 wt %, preferably about 0.5-1.5 wt %, on a dry weight basis.
   Aspect 33. The coating composition of any of aspects 17-32 further comprising a solvent.
   Aspect 34. The coating composition of aspect 33, wherein the solvent is selected from the group consisting of dibasic esters, cyclohexanone, aromatic 100, aromatic 150, aromatic 200, methyl propyl acetate, toluene, methyl ethyl ketone, and methyl propyl ketone and mixtures thereof.
   Aspect 35. The coating composition of any of aspects 17-34, wherein the cross-linker has an activation temperature above 75° C., preferably 100° C., more preferably 125° C., and most preferably above 145° C.
   Aspect 36. The coating composition of any of aspects 17-35, wherein the cross-linker is selected from the group consisting of an amine, a blocked isocyanate, a phenolic resin, and mixtures thereof.
   Aspect 37. A method of coating a metal surface comprising the steps of:
combining a coating composition according to any of aspects 17-32, 35, or 36, with a solvent to form a solvated coating composition;
applying the solvated coating composition to the metal surface; and
curing the solvated coating composition to form a coated metal substrate.
   Aspect 38. The method of aspect 37, wherein the metal comprises tin-plated steel.
   Aspect 39. The method of aspects 37 or 38, wherein the metal adapted to be a container of a beverage.
   Aspect 40. The method of any of aspects 37-39, wherein the beverage is an alcoholic beverage.
   Aspect 41. A coated article comprising a metal substrate and a coating, disposed on the metal substrate, and comprising a cross-linked copolyester resin, wherein said resin comprises residues of at least one aliphatic diol and at least one aromatic diacid or diester comprising a naphthalene-based monomer, wherein said coating provides a blush resistance test rating of at least 4, preferably at least 4.5; a wedge bend percentage of at least 70%, preferably at least 75%; a solvent resistance rating using methyl ethyl ketone of at least 30 double rubs, preferably at least 40 double rubs; an adhesion test rating of at least 8, preferably at least 9; and a pencil test rating of 8H or harder.

### EXAMPLES

The following examples demonstrate several aspects of certain preferred embodiments of the present invention, and are not to be construed as limitations thereof.

### Example 1

To a 2 liter glass flask was added dimethyl terephthalate, (638.91 grams), dimethyl 2,6-naphthalene dicarboxylate (321.43 grams), ethylene glycol (245.06 grams), neopentyl glycol (411.20 grams), zinc acetate dihydrate (0.31 grams), and titanium(IV) butoxide (0.69 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (327.98 grams), ethylene glycol (61.27 grams), neopentyl glycol (102.80 grams), and titanium (IV) 2-ethylhexyloxide (0.06 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 100 grams of a colorless distillate was collected over this heating cycle. The reaction mixture was then staged to full vacuum with stirring at 255° C. The resulting reaction mixture was stirred for 4 hours under full vacuum, (pressure less than 5 torr). The vacuum was then released with nitrogen and the reaction mass was transferred to a PTFE tray and allowed to cool to room temperature. About an additional 150 grams of distillate was recovered and 1.25 kilograms of a solid product was recovered. A sample of the product was tested to have an inherent viscosity, (IV), of 0.53 dL/g. The sample also underwent differential scanning calorimetry, (DSC), analysis. A glass transition temperature, (Tg), was observed at 79.7° C.

### Example 2

To a 2 liter glass flask was added dimethyl terephthalate, (624.90 grams), dimethyl 2,6-naphthalene dicarboxylate (471.58 grams), ethylene glycol (239.69 grams), neopentyl glycol (402.19 grams), zinc acetate dihydrate (0.31 grams), and titanium (IV) butoxide (0.69 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 220 grams of a colorless distillate was collected over this heating cycle. At this point to the flask was added isophthalic acid (213.86 grams), ethylene glycol (59.92 grams), neopentyl glycol (100.55 grams), and titanium (IV) 2-ethylhexyloxide (0.06 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 90 grams of a colorless distillate was collected over this heating cycle. The reaction mixture was then staged to full vacuum with stirring at 255° C. The resulting reaction mixture was stirred for 3.5 hours under full vacuum, (pressure less than 5 torr). The vacuum was then released with nitrogen and the reaction mass was transferred to a PTFE tray and allowed to cool to room temperature. About an additional 150 grams of distillate was recovered and 1.22 kilograms of a solid product was recovered. A sample of the product was tested to have an inherent viscosity, (IV), of 0.43 dL/g. The sample also underwent differential scanning calorimetry, (DSC), analysis. A glass transition temperature, (Tg), was observed at 82.5° C.

### Example 3

To a 2 liter glass flask was added dimethyl terephthalate (592.41 grams), dimethyl 2,6-naphthalene dicarboxylate (372.55 grams), ethylene glycol (227.23 grams), neopentyl glycol (190.64 grams), 1,4-cyclohexanedimethanol (263.96 grams), zinc acetate dihydrate (0.30 grams), and titanium (IV) butoxide (0.69 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 190 grams of a colorless distillate was collected over this heating cycle. At this point to the flask was added isophthalic acid (253.42 grams), ethylene glycol (56.81 grams), neopentyl glycol (47.66 grams), 1,4-cyclohexanedimethanol (65.99 grams), and titanium (IV) 2-ethylhexyloxide (0.06 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 70 grams of a colorless distillate was collected over this heating cycle. The reaction mixture was then staged to full vacuum with stirring at 255° C. The resulting reaction mixture was stirred for 4 hours under full vacuum, (pressure less than 5 torr). The vacuum was then released with nitrogen and the reaction mass was transferred to a PTFE tray and allowed to cool to room temperature. About an additional 120 grams of distillate was recovered and 1.19 kilograms of a solid product was recovered. A sample of the product was tested to have an inherent viscosity, (IV), of 0.52 dL/g. The sample also underwent differential scanning calorimetry, (DSC), analysis. A glass transition temperature, (Tg), was observed at 85.0° C.

### Example 4

To a 2 liter glass flask was added dimethyl terephthalate (601.16 grams), dimethyl 2,6-naphthalene dicarboxylate (378.05 grams), ethylene glycol (230.58 grams), 1,4-butanediol (167.41 grams), 1,4-cyclohexanedimethanol (267.86 grams), zinc acetate dihydrate (0.30 grams), and titanium (IV) butoxide (0.69 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (257.16 grams), ethylene glycol (57.65 grams), 1,4-butanediol (41.85 grams), 1,4-cyclohexanedimethanol (66.97 grams), and titanium (IV) 2-ethylhexyloxide (0.06 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 70 grams of a colorless distillate was collected over this heating cycle. The reaction mixture was then staged to full vacuum with stirring at 255° C. The resulting reaction mixture was stirred for 6 hours under full vacuum, (pressure less than 5 torr). The vacuum was then released with nitrogen and the reaction mass was transferred to a PTFE tray and allowed to cool to room temperature. About an additional 120 grams of distillate was recovered and 1.23 kilograms of a solid product was recovered. A sample of the product was tested to have an inherent viscosity, (IV), of 0.56 dL/g. The sample also underwent differential scanning calorimetry, (DSC), analysis. A glass transition temperature, (Tg), was observed at 74.73° C.

### Example 5

To a 2 liter glass flask was added dimethyl terephthalate (602.58 grams), dimethyl 2,6-naphthalene dicarboxylate (378.94 grams), ethylene glycol (240.37 grams), 2-methyl-1,3-propanediol (36.36 grams), 1,4-cyclohexanedimethanol (232.70 grams), zinc acetate dihydrate (0.28 grams), and titanium (IV) butoxide (0.64 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (257.77 grams), ethylene glycol (60.09 grams), 1,4-cyclohexanedimethanol (58.17 grams), and titanium (IV) 2-ethylhexyloxide (0.05 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 6 hours under full vacuum, (pressure less than 5 torr). The vacuum was then released with nitrogen and the reaction mass was transferred to a PTFE tray and allowed to cool to room temperature. About an additional 130 grams of distillate was recovered and 1.22 kilograms of a solid product was recovered. A sample of the product was tested to have an inherent viscosity, (IV), of 0.51 dL/g. The sample also underwent differential scanning calorimetry, (DSC), analysis. A glass transition temperature, (Tg), was observed at 71.74° C.

### Example 6

To a 2 liter glass flask was added dimethyl terephthalate (500.40 grams), dimethyl 2,6-naphthalene dicarboxylate (472.03 grams), ethylene glycol (313.50 grams), diethylene glycol (95.71 grams), 1,4-cyclohexanedimethanol (208.10 grams), zinc acetate dihydrate (0.30 grams), and titanium (IV) butoxide (0.68 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (321.09 grams), ethylene glycol (78.37 grams), and 1,4-cyclohexanedimethanol (52.03 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 3 hours under full vacuum, (pressure less than 5 torr). The vacuum was then released with nitrogen and the reaction mass was transferred to a PTFE tray and allowed to cool to room temperature. About an additional 150 grams of distillate was recovered and 1.24 kilograms of a solid product was recovered. A sample of the product was tested to have an inherent viscosity, (IV), of 0.52 dL/g. The sample also underwent differential scanning calorimetry, (DSC), analysis. A glass transition temperature, (Tg), was observed at 79.30° C.

### Example 7

To a 2 liter glass flask was added dimethyl terephthalate (500.52 grams), dimethyl 2,6-naphthalene dicarboxylate (472.14 grams), ethylene glycol (313.57 grams), diethylene glycol (95.73 grams), 1,4-cyclohexanedimethanol (208.15 grams), zinc acetate dihydrate (0.30 grams), and titanium (IV) butoxide (0.34 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (321.17 grams), ethylene glycol (78.39 grams), and 1,4-cyclohexanedimethanol (52.04 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 3 hours under full vacuum, (pressure less than 5 torr). The vacuum was then released with nitrogen and the reaction mass was transferred to a PTFE tray and allowed to cool to room temperature. About an additional 140 grams of distillate was recovered and 1.23 kilograms of a solid product was recovered. A sample of the product was tested to have an inherent viscosity, (IV), of 0.52 dL/g. The sample also underwent differential scanning calorimetry, (DSC), analysis. A glass transition temperature, (Tg), was observed at 78.02° C.

### Example 8

To a 2 liter glass flask was added dimethyl terephthalate (500.52 grams), dimethyl 2,6-naphthalene dicarboxylate (472.14 grams), ethylene glycol (313.57 grams), diethylene glycol (95.73 grams), 1,4-cyclohexanedimethanol (260.19 grams), zinc acetate dihydrate (0.30 grams), and titanium (IV) butoxide (0.34 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 210 grams of a colorless distillate was collected over this heating cycle. At this point to the flask was added isophthalic acid (321.17 grams) and ethylene glycol (78.39 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 1.25 hours under full vacuum, (pressure less than 5 torr). The vacuum was then released with nitrogen and the reaction mass was transferred to a PTFE tray and allowed to cool to room temperature. About an additional 150 grams of distillate was recovered and 1.26 kilograms of a solid product was recovered. A sample of the product was tested to have an inherent viscosity, (IV), of 0.39 dL/g. The sample also underwent differential scanning calorimetry, (DSC), analysis. A glass transition temperature, (Tg), was observed at 76.96° C.

### Example 9

To a 2 liter glass flask was added dimethyl terephthalate (509.09 grams), dimethyl 2,6-naphthalene dicarboxylate (480.23 grams), ethylene glycol (318.94 grams), diethylene glycol (194.74 grams), 1,4-cyclohexanedimethanol (105.86 grams), zinc acetate dehydrate (0.30 grams), and titanium (IV) butoxide (0.34 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 200 grams of a colorless distillate was collected over this heating cycle. At this point to the flask was added isophthalic acid (326.67 grams), 1,4-cyclohexanedimethanol (26.46 grams), and ethylene glycol (79.73 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 3 hours under full vacuum, (pressure less than 5 torr). The vacuum was then released with nitrogen and the reaction mass was transferred to a PTFE tray and allowed to cool to room temperature. About an additional 150 grams of distillate was recovered and 1.24 kilograms of a solid product was recovered. A sample of the product was calculated to have an inherent viscosity, (IV), of 0.48 dL/g. The sample also underwent differential scanning calorimetry, (DSC), analysis. A glass transition temperature, (Tg), was observed at 74.52° C.

### Example 10

To a 2 liter glass flask was added dimethyl terephthalate (491.55 grams), dimethyl 2,6-naphthalene dicarboxylate (463.68 grams), ethylene glycol (285.95 grams), diethylene glycol (94.02 grams), 1,4-cyclohexanedimethanol (255.53 grams), zinc acetate dehydrate (0.30 grams), and titanium (IV) butoxide (0.68 grams). The reaction mixture was stirred and heated to 204° C. under a slow nitrogen purge. After reaching 204° C., the reaction mixture was stirred for about 1.5 hours with a slight nitrogen purge, until the distillation temperature at the top of the column dropped below 60° C. About 220 grams of a colorless distillate was collected over this heating cycle. At this point to the flask was added isophthalic acid (315.41 grams), 1,4-cyclohexanedimethanol (63.88 grams), and ethylene glycol (71.49 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 90 grams of a colorless distillate was collected over this heating cycle. The reaction mixture was then staged to full vacuum with stirring at 255° C. The resulting reaction mixture was stirred for 3 hours under full vacuum, (pressure less than 5 torr). The vacuum was then released with nitrogen and the reaction mass was transferred to a PTFE tray and allowed to cool to room temperature. About an additional 150 grams of distillate was recovered and 1.20 kilograms of a solid product was recovered. A sample of the product was calculated to have an inherent viscosity, (IV), of 0.45 dL/g. The sample also underwent differential scanning calorimetry, (DSC), analysis. A glass transition temperature, (Tg), was observed at 78.90° C.

### Example 11

To a 2 liter glass flask was added dimethyl terephthalate (466.94 grams), dimethyl 2,6-naphthalene dicarboxylate (440.47 grams), ethylene glycol (208.95 grams), diethylene glycol (89.31 grams), 1,4-cyclohexanedimethanol (485.47 grams), zinc acetate dehydrate (0.30 grams), and titanium(IV) butoxide (0.34 grams). The reaction mixture was stirred and heated to 204° C. under a slow nitrogen purge. After reaching 204° C. the reaction mixture was stirred for about 1.5 hours with a slight nitrogen purge, until the distillation temperature at the top of the column dropped below 60° C. About 215 grams of a colorless distillate was collected over this heating cycle. At this point to the flask was added isophthalic acid (299.62 grams) and ethylene glycol (52.24 grams). The reaction mixture was then heated to 200° C. over 0.4 hours with stirring under a slow nitrogen purge. The resulting reaction mixture was stirred at 200° C. under a slight nitrogen purge for about 2 hours, or until the distillation temperature at the top of the column dropped below 90° C. The reaction mixture was then heated to 255° C. over 1.5 hours with stirring under a slight nitrogen purge. About 80 grams of a colorless distillate was collected over this heating cycle. The reaction mixture was then staged to full vacuum with stirring at 255° C. The resulting reaction mixture was stirred for 3 hours under full vacuum, (pressure less than 5 torr). The vacuum was then released with nitrogen and the reaction mass was transferred to a PTFE tray and allowed to cool to room temperature. About an additional 150 grams of distillate was recovered and 1.18 kilograms of a solid product was recovered. A sample of the product was calculated to have an inherent viscosity, (IV), of 0.49 dL/g. The sample also underwent differential scanning calorimetry, (DSC), analysis. A glass transition temperature, (Tg), was observed at 84.51° C.

### Coating Composition

The solid copolyester products from the previous experiments were each solvated at a solids of 30% to 40% by weight in one of the following solvent combinations: (1) 69% (all by weight) aromatic 100 and 31% cyclohexanone or (2) 44% dibasic esters, 38% aromatic 100, and 18% butylglycol. To this solution was added a crosslinker component consisting of 20% benzoguanamine (commercially available as CYMEL 1123) and 10% blocked isocyanate (commercially available as DESMODUR BL 2078/2 from Covestro AG), each based on the weight of the copolyester resin. This was followed by an addition of a para-toluene sulfonic acid catalyst (commercially available as CYCAT 4040) or phosphoric acid catalyst (commercially available as CYCAT XK 406N) at 0.5% to 1% by weight. The coating to be evaluated was applied to a 100 mm×150 mm (4″×6″) tin plated aluminum panel at a dry film thickness of 10 to 15 grams per square meter, with 13 gsm being the target thickness. The coated panel was cured for 12 minutes (total oven time) in a suitably heated oven so that a peak metal temperature of 204° C. was achieved for 8 minutes. Results from testing can be found in Table 1 below.

### Test Methods

### Retort Resistance

These tests are a measure of the coating integrity of the coated substrate after exposure to heat and pressure with a liquid such as deionized water, 1% NaCl, or 3% acetic acid solutions. Retort performance is not necessarily required for all food and beverage coatings, but is desirable for some product types that are packed under retort conditions. This test provides an indication of an ability of a coating to withstand conditions frequently associated with food or beverage preservation or sterilization. For the present evaluation, coated substrate samples (in the form of flat panels with a wedge bend on the bottom) were placed in a vessel and partially immersed in each solution. The retort method was as follows: While partially immersed in the test solution, the coated substrate samples were placed in an autoclave and subjected to heat of 121° C. and pressure of 20 psi for a time period of 90 minutes. Just after retort, the coated substrate samples were tested for adhesion and blush resistance as described below and submerged in copper sulfate solution for 2 minutes.

### Blush Resistance Test

Blush resistance measures the ability of a coating to resist attack by various solutions. Typically, blush is measured by the amount of water absorbed into a coated film. When the film absorbs water, it generally becomes cloudy or looks white. Blush is generally measured visually using a scale of 0-5 where a rating of “5” indicates no blush, a rating of “4” indicates slight whitening of the film, a rating of “3” indicates whitening of the film, a rating of “2” indicates severe whitening of the film, a rating of “1” indicates severe whitening of the film with coating failure, and a rating of “0” indicates complete coating delamination. Blush ratings of 4 or more are typically desired for commercial packaging coatings and optimally 4.5 or above.

### Wedge Bend Test

This test provides an indication of a level of flexibility of a coating and an extent of cure. For the present evaluation, test wedges were formed from coated rectangular metal test sheets (which measured 150 mm long by 100 mm wide). Test wedges were formed from the coated sheets by folding (i.e., bending) the sheets around a mandrel. To accomplish this, the mandrel was positioned on the coated sheets so that it was oriented parallel to the 100 mm edge of the sheets. The resulting test wedges had a 4 mm wedge diameter and a length of 100 mm. To assess the wedge bend properties of the coatings, the test wedges were positioned lengthwise in a metal block of a wedge bend tester and a 2.4 kg weight was dropped onto the test wedges from a height of 60 cm.

The deformed test wedges were then immersed in a copper sulphate test solution (prepared by combining 20 parts of CuSO4·5H2O, 70 parts of deionized water, and 10 parts of hydrochloric acid (36%)) for about 2 minutes. The exposed metal was examined under a microscope and the millimeters of coating failure along the deformation axis of the test wedges was measured. The results of this test for coatings prepared according to the present invention are expressed as a wedge bend percentage using the following calculation:

100%×[(100 mm)−(mm of failure)]/(100 mm)

A coating is considered herein to satisfy the Wedge Bend Test if it exhibits a wedge bend percentage of 70% or more.

### Solvent Resistance Test

The extent of “cure’ or crosslinking of a coating is measured as a resistance to solvents, such as methyl ethyl ketone (MEK) or isopropyl alcohol (IPA). This test is performed as described in ASTM D5402-93, with the exception that the cheesecloth was affixed to a 32-ounce ball-peen hammer in order to apply constant pressure. The number of double-rubs (i.e., one back-and-forth motion) before coating failure is reported, with rubbing ceased at 100 double-rubs if no coating failure is observed. Preferably, the MEK solvent resistance is at least 30 double rubs, with the number of double rubs being referred to herein as the solvent resistance rating.

### Adhesion Test

Adhesion testing was performed to assess whether the coating compositions adhere to the underlying substrate. The adhesion test was performed according to ASTM D3359-Test Method B, using SCOTCH 610 tape, available from 3M Company of Saint Paul, Minn. Adhesion is generally rated on a scale of 0-10 where a rating of “10 indicates no adhesion failure, a rating of “9 indicates 90% of the coating remains adhered, a rating of “8” indicates 80% of the coating remains adhered, and so on. A coating is considered herein to satisfy the adhesion test if it exhibits an adhesion rating of at least 8.

### Scratch Resistance Test

Scratch resistance testing was performed to determine the hardness of the finished coating. The test was performed using a pencil hardness tester according to the Wolff-Wilborn Pencil Hardness test, utilizing pencil leads ranging from 2B to 9H. The higher the lead rating, the better the scratch resistance of the coating.

TABLE 1A

| | | | | | | |
|---|---|---|---|---|---|---|
| TEST | 1 | 2 | 3 | 4 | 5 | 6 |

COATING PROPERTIES (EXAMPLE 1-6)

| | | | | | | |
|---|---|---|---|---|---|---|
| MEK RUB | >40× | >40× | >40× | >40× | >40× | >40× |
| WEDGE BEND (%) | 90% | 90% | 90% | 100% | 100% | 100% |
| RETORT-3% ACETIC | 4 | 4 | 4 | 4.5 | 4 | 4.5 |
| ACID (LIQUID) | | | | | | |
| RETORT -3% ACETIC | 5 | 5 | 4.5 | 5 | 5 | 5 |
| ACID (VAPOR) | | | | | | |
| RETORT-1% NACL | 5 | 5 | 5 | 5 | 5 | 5 |
| (LIQUID) | | | | | | |
| RETORT-1% NACL | 5 | 5 | 5 | 5 | 5 | 5 |
| (VAPOR) | | | | | | |
| RETORT-DI WATER | 4.5 | 4.5 | 4 | 4 | 4 | 4.5 |
| (LIQUID) | | | | | | |
| RETORT-DI WATER | 5 | 5 | 5 | 5 | 4.5 | 5 |
| (VAPOR) | | | | | | |
| ADHESION | 100/100 | 100/100 | 100/100 | 100/100 | 100/100 | 100/100 |
| FILM | 8H | 8H | 8H | 8H | 8H | 8H |
| HARDNESS-PENCIL | | | | | | |

| | | | | | |
|---|---|---|---|---|---|
| TEST | 7 | 8 | 9 | 10 | 11 |

COATING PROPERTIES (EXAMPLE 7-11)

| | | | | | |
|---|---|---|---|---|---|
| MEK RUB | >40× | >40× | >40× | >40× | >40× |
| WEDGE BEND (%) | 100% | 100% | 85% | 100% | 75% |
| RETORT-3% ACETIC | 4.5 | 4.5 | 4 | 4.5 | 4 |
| ACID (LIQUID) | | | | | |
| RETORT-3% ACETIC | 5 | 5 | 5 | 5 | 5 |
| ACID (VAPOR) | | | | | |
| RETORT-1% NACL | 5 | 5 | 5 | 5 | 5 |
| (LIQUID) | | | | | |
| RETORT-1% NACL | 5 | 5 | 5 | 5 | 5 |
| (VAPOR) | | | | | |
| RETORT-DI WATER | 4.5 | 5 | 4 | 4.5 | 4 |
| (LIQUID) | | | | | |
| RETORT-DI WATER | 5 | 5 | 4.5 | 5 | 4.5 |
| (VAPOR) | | | | | |
| ADHESION | 100/100 | 100/100 | 100/100 | 100/100 | 100/100 |
| FILM | 8H | 8H | 8H | 8H | 8H |
| HARDNESS-PENCIL | | | | | |

We claim:

1. A composition comprising an amorphous copolyester resin comprising the reaction product of at least two aliphatic diols and at least two aromatic diacids or diesters, wherein said at least two aromatic diacids or diesters comprise a naphthalene-based monomer in an amount of at least 20 mol %, preferably at least 22.5 mol %, and more preferably at least 25 mol % and at most 60 mol % and a terephthalic-based monomer in an amount of at least 20 mol %, preferably 35 mol %, and at most 60 mol %, preferably at most 45 mol %, based on the total moles of diacids and diesters and having a glass transition temperature between about 65° C. and about 95° C., preferably between about 73° C. and about 81° C.

2. The composition of claim 1, wherein the copolyester does not comprise any residue of neopentyl glycol or 2-methyl-1,3-propanediol.

3. The composition of claim 1, wherein all of the diacid and diester components are aromatic and all of the diol components are aliphatic.

4. The composition of claim 1, wherein the at least two aliphatic diols comprise ethylene glycol, diethylene glycol, and cyclohexanedimethanol.

5. The composition of claim 4, wherein:
the ethylene glycol is present in an amount of 55-80 mol %, preferably 65-75 mol %, based on the total moles of diols;
the diethylene glycol is present in an amount of 5-40 mol %, preferably 7-15 mol %, based on the total moles of diols; and
the cyclohexanedimethanol is present in an amount of 10-35 mol %, preferably 15-25 mol %, based on the total moles of diols.

6. The composition of claim 1, wherein the naphthalene-based monomer is selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, 2,6-naphthalene dicarboxylic acid, dimethyl 2,6-naphthalene dicarboxylate, and dimethyl 2,7-naphthalene dicarboxylate.

7. The composition of claim 1, wherein naphthalene-based monomer is 2,6-naphthalene dicarboxylic acid or dimethyl 2,6-naphthalene dicarboxylate.

8. The composition of claim 7, wherein the at least two aromatic diacids or diesters further comprise isophthalic-based monomer.

9. The composition of claim 8, wherein naphthalene-based monomer is dimethyl 2,6-naphthalene dicarboxylate, the terephthalic-based monomer is dimethyl terephthalate, and wherein:
the isophthalic acid is present in an amount of 15-50 mol %, preferably 25-35 mol %, based on the total moles of diacids and diesters; and
the 2,6-naphthalene dicarboxylate is present in an amount of 25-35 mol %, based on the total moles of diacids and diesters.

10. The composition of claim 1, wherein the only source of ether groups in the copolyester resin is diethylene glycol and the amount of diethylene glycol based on the total moles of the diols is at most 30 mol %, preferably at most 20 mol %, and most preferably at most 15 mol %.

11. The composition of claim 1, wherein the amorphous copolyester resin has an acid number of less than 5, preferably less than 3 mg KOH/g but greater than 0.1, preferably greater than 0.5 mg KOH/g, and a hydroxyl number of less than 20 mg KOH/g, preferably less 17 mg KOH/g but greater than 5 mg KOH/g, preferably greater than 8 mg KOH/g.

12. The composition of claim 1, wherein the amorphous copolyester resin has a number average molecular weight (Mn) of between about 8000 to 30,000 daltons, preferably between about 17,000 and 24,000 daltons, and a weight average molecular weight (Mw) of between about 20,000 to 45,000 daltons, preferably between about 27,000 to 40,000 daltons.

13. The composition of claim 1, wherein the amorphous copolyester resin has a Brookfield Thermosel melt viscosity at 215° C. of between 85,000 and 500,000 cP with a #29 spindle at 0.5 rpm and/or an intrinsic viscosity determined in accordance with ASTM D5225-14 between about 0.3 dl/g to about 0.6 dl/g, preferably between about 0.35 dl/g to about 0.55 dl/g.

14. The composition of claim 1, wherein terephthalic-based monomer is dimethyl terephthalate, the at least two aliphatic diols comprise ethylene glycol, and the combined amount of ethylene glycol molar fraction based on the total moles of the diols and dimethyl terephthalate molar fraction based on the total moles of the diacids and diesters is less than 1.3, preferably less than 1.25, most preferably less than 1.2.

15. The composition of claim 1, wherein the at least two aliphatic diols comprise diethylene glycol, the at least two aromatic diacids or diesters further comprise isophthalic acid, and the combined amount of diethylene glycol molar fraction based on the total moles of the diols and isophthalic acid molar fraction based on the total moles of the diacids and diesters is at least 0.25, preferably at least 0.3, and most preferably at least 0.35.

16. The composition of claim 1, wherein all of the diol components consist of primary alcohols.

17. A coating composition comprising:
an amorphous copolyester resin having a glass transition temperature between about 65° C. and 95° C., preferably between about 73° C. and about 81° C., and comprising the reaction product of at least two aliphatic diols and at least one aromatic diacid or diester, wherein said at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid or diester;
a cross-linker; and
a metal catalyst.

18. The coating composition of claim 17, wherein all of the diacid and diester components are aromatic and all of the diol components are aliphatic.

19. The coating composition of claim 17, wherein the at least two aliphatic diols comprise ethylene glycol, diethylene glycol, and cyclohexanedimethanol.

20. The coating composition of claim 19, wherein:
the ethylene glycol is present in an amount of 55-80 mol %, preferably 65-75 mol %, based on the total moles of diols;
the diethylene glycol is present in an amount of 5-40 mol %, preferably 7-15 mol %, based on the total moles of diols; and
the cyclohexanedimethanol is present in an amount of 10-35 mol %, preferably 15-25 mol %, based on the total moles of diols.

21. The coating composition of claim 17, wherein naphthalene-based monomer is selected from the group consisting of dimethyl 1,2-naphthalene dicarboxylate, dimethyl 1,4-naphthalene dicarboxylate, dimethyl 1,5-naphthalene dicarboxylate, dimethyl 1,6-naphthalene dicarboxylate, dimethyl 1,7-naphthalene dicarboxylate, dimethyl 1,8-naphthalene dicarboxylate, dimethyl 2,3-naphthalene dicarboxylate, 2,6-naphthalene dicarboxylic acid, dimethyl 2,6-naphthalene dicarboxylate, and dimethyl 2,7-naphthalene dicarboxylate.

22. The coating composition of claim 17, wherein naphthalene-based monomer is 2,6-naphthalene dicarboxylic acid or dimethyl 2,6-naphthalene dicarboxylate.

23. The coating composition of claim 22, wherein the at least one aromatic diacid further comprises a terephthalic-based monomer and an isophthalic-based monomer.

24. The coating composition of claim 23, wherein naphthalene-based monomer is dimethyl 2,6-naphthalene dicarboxylate, the terephthalic-based monomer is dimethyl terephthalate, and the isophthalic-based monomer is isophthalic acid, and wherein:
the dimethyl terephthalate is present in an amount of 20-60 mol %, preferably 35-45 mol %, based on the total moles of diacid;
the isophthalic acid is present in an amount of 15-50 mol %, preferably 25-35 mol %, based on the total moles of diacid; and
the dimethyl 2,6-naphthalene dicarboxylate is present in an amount of 25-35 mol %, based on the total moles of diacid.

25. The coating composition of claim 17, wherein the only source of glycol of ether groups in the copolyester resin is diethylene glycol and the amount of diethylene glycol based on the total moles of the diols is at most 30 mol %, preferably at most 20 mol %, and most preferably at most 15 mol %.

26. The coating composition of claim 17, wherein the amorphous copolyester resin has an acid number of less than 5 mg KOH/g, preferably less than 3 mg KOH/g but greater than 0.1 mg KOH/g, preferably greater than 0.5 mg KOH/g, and a hydroxyl number of less than 20 mg KOH/g, preferably less 17 mg KOH/g but greater than 5 mg KOH/g, preferably greater than 8 mg KOH/g.

27. The coating composition of claim 17, wherein the amorphous copolyester resin has a number average molecular weight (Mₙ) of between about 8,000 to 30,000 daltons, preferably between about 17,000 and 24,000 daltons, and a weight average molecular weight (M_{w}) of between about 20,000 to 45,000 daltons, preferably between about 27,000 to 40,000 daltons.

28. The coating composition of claim 17, wherein the amorphous copolyester resin has a Brookfield Thermosel melt viscosity at 215° C. of between 85,000 and 500,000 cP with a #29 spindle at 0.5 rpm and/or an intrinsic viscosity determined in accordance with ASTM D5225-14 between about 0.3 dl/g to about 0.6 dl/g, preferably between about 0.35 dl/g to about 0.55 dl/g.

29. The coating composition of claim 17, wherein the at least two aliphatic diols comprise ethylene glycol, the at least one aromatic diacid or diester further comprises dimethyl terephthalate, and the combined amount of ethylene glycol molar fraction based on the total moles of the diols and dimethyl terephthalate molar fraction based on the total moles of the diacids and diesters is less than 1.3, preferably less than 1.25, most preferably less than 1.2.

30. The coating composition of claim 17, wherein the at least two aliphatic diols comprise diethylene glycol, the at least one aromatic diacid or diester further comprises isophthalic acid, and the combined amount of diethylene glycol molar fraction based on the total moles of the diols and isophthalic acid molar fraction based on the total moles of the diacids and diesers is at least 0.25, preferably at least 0.3, and most preferably at least 0.35.

31. The coating composition of claim 17, wherein all of the diol components consist of primary alcohols.

32. The coating composition of claim 17, wherein:
the amorphous copolyester resin is present in an amount of about 60-85 wt %, preferably about 67-80 wt %, on a dry weight basis;
the cross-linker is present in an amount of about 15-35 wt %, preferably about 20-32.5 wt %, on a dry weight basis; and
the catalyst is present in an amount of about 0.1-3 wt %, preferably about 0.5-1.5 wt %, on a dry weight basis.

33. The coating composition of claim 17 further comprising a solvent.

34. The coating composition of claim 33, wherein the solvent is selected from the group consisting of dibasic esters, cyclohexanone, aromatic 100, aromatic 150, aromatic 200, methyl propyl acetate, toluene, methyl ethyl ketone, and methyl propyl ketone and mixtures thereof.

35. The coating composition of claim 17, wherein the cross-linker has an activation temperature above 75° C., preferably 100° C., more preferably 125° C., and most preferably above 145° C.

36. The coating composition of claim 17, wherein the cross-linker is selected from the group consisting of an amine, a blocked isocyanate, a phenolic resin, and mixtures thereof.

37. A method of coating a metal surface comprising the steps of:
combining a coating composition with a solvent to form a solvated coating composition, wherein the coating composition comprises:
an amorphous copolyester resin having a glass transition temperature between about 65° C. and 95° C., preferably between about 73° C. and about 81° C., and comprising the reaction product of at least two aliphatic diols and at least one aromatic diacid or diester, wherein said at least one aromatic diacid or diester comprises a naphthalene-based monomer in an amount of at least 20 mol %, preferably at least 22.5 mol %, and more preferably at least 25 mol % and at most 60 mol %, based on the total moles of the at least one diacid or diester;
a cross-linker; and
a metal catalyst;
applying the solvated coating composition to the metal surface; and
curing the solvated coating composition to form a coated metal substrate.

38. The method of claim 37, wherein the metal comprises tin-plated steel.

39. The method of claim 37, wherein the metal adapted to be a container of a beverage.

40. The method of claim 39, wherein the beverage is an alcoholic beverage.

41. A coated article comprising a metal substrate and a coating, disposed on the metal substrate, and comprising a cross-linked copolyester resin, wherein said resin comprises residues of at least one aliphatic diol and at least one aromatic diacid or diester comprising a naphthalene-based monomer, wherein said coating provides a blush resistance test rating of at least 4, preferably at least 4.5; a wedge bend percentage of at least 70%, preferably at least 75%; a solvent resistance rating using methyl ethyl ketone of at least 30 double rubs, preferably at least 40 double rubs; an adhesion test rating of at least 8, preferably at least 9; and a pencil test rating of 8H or harder.
